(19) United States
(12) Patent Application Publication
(10) Pub. No.: US 2017/0315284 A1
(43) Pub. Date: Nov. 2, 2017

(54) BACKLIGHT MODULE AND LIQUID CRYSTAL DISPLAY DEVICE

(71) Applicants: Shenzhen China Star Optoelectronics Technology Co., Ltd., Shenzhen, Guangdong (CN); Wuhan China Star Optoelectronics Technology Co., Ltd., Wuhan, Hubei (CN)

(72) Inventor: Jiangfeng Wang, Shenzhen, Guangdong (CN)

(73) Assignees: Shenzhen China Star Optoelectronics Technology Co., Ltd., Shenzhen, Guangdong (CN); Wuhan China Star Optoelectronics Technology Co., Ltd., Wuhan, Hubei (CN)

(21) Appl. No.: 14/778,172

(22) PCT Filed: Jun. 16, 2015
(86) PCT No.: PCT/CN2015/081531

§ 371 Date: Dec. 10, 2015

(30) Foreign Application Priority Data
May 22, 2015 (CN) 201510268782.1

(51) Int. Cl. F21V 8/00

(52) U.S. Cl. CPC G02B 6/005

(57) ABSTRACT

A backlight module and a liquid crystal display device are disclosed. The backlight module comprises a light guide plate, an optical diaphragm group that is arranged on one side of the light guide plate, and a collimation diaphragm group that is arranged between the light guide plate and the optical diaphragm group. According to the present disclosure, on the one hand, the viewing angle of the backlight module can be reduced through arranging the collimation diaphragm group appropriately, such as the thicknesses of collimation diaphragms, a number of layers thereof, and a refractive index of each layer, so that the requirement of special users can be met. On the other hand, the assembling of the collimation diaphragm group can be simplified through arranging the position thereof. Moreover, in the backlight module according to the present disclosure, since the light is more convergent, the brightness of the backlight module can be improved and the power consumption thereof can be reduced.

### CROSS REFERENCE TO RELATED APPLICATION

The present application claims benefit of Chinese patent application CN 201510268782.1, entitled “Backlight Module and Liquid Crystal Display Device” and filed on May 22, 2015, the entirety of which is incorporated herein by reference.

### FIELD OF THE INVENTION

The present disclosure relates to the technical field of liquid crystal display, and particularly to a backlight module and a liquid crystal display device.

### BACKGROUND OF THE INVENTION

In a backlight module in the prior art, the light that is emitted by the backlight source generally emits out from the backlight module at various angles after being scattered by lattices arranged on a light guide plate. Therefore, the backlight module has a relatively wide viewing angle. The wide viewing angle means that a user can obtain a good visual experience in various directions, which is popular with the user in many situations. However, in some special situations, the user would hope to obtain a narrow viewing angle. For example, when the user processes confidential information with a mobile phone or a tablet personal computer in an airplane or a high speed train, he or she does not hope the information to be seen by a passenger in an adjacent seat. In this situation, the backlight module should have a narrow viewing angle, so that the user who faces the screen directly can see the screen clearly, while the passenger in the adjacent seat cannot see the screen.

In order to eliminate the technical defect in the prior art, a backlight module with a narrow viewing angle is needed to meet the requirement of special users.

### SUMMARY OF THE INVENTION

In order to meet the requirement of special users for the viewing angle of the backlight module, the present disclosure provides a new backlight module and a liquid crystal display device comprising the backlight module.

According to the present disclosure, the backlight module comprises a light guide plate, an optical diaphragm group that is arranged on one side of the light guide plate, and a collimation diaphragm group that is arranged between the light guide plate and the optical diaphragm group.

In the backlight module according to the present disclosure, on the one hand, the collimation diaphragm group is designed appropriately. That is, through selecting thicknesses of collimation diaphragms, a number of layers thereof, and a refractive index of each layer, the light can be made more convergent after passing through the collimation diaphragm group. In this case, the viewing angle of the backlight module can be reduced, and thus the requirement of special users can be met. On the other hand, a satisfactory effect of the collimation diaphragm group can be obtained through arranging a position of the collimation diaphragm group, so that the assembling thereof can be simplified. Moreover, in the backlight module according to the present disclosure, the light is more convergent since the viewing angle is reduced. Therefore, the brightness of the backlight module can be improved, and a power consumption of the backlight module can be reduced.

According to some implementations, the collimation diaphragm group consists of a plurality of transparent material layers with different refractive indexes in a laminated manner. The viewing angle of the backlight module can be controlled through controlling the refractive indexes of different transparent material layers and the number of layers thereof. The more layers there are, and the larger the refractive index difference between two adjacent layers would be, the smaller the viewing angle of the backlight module would become.

According to some implementations, the collimation diaphragm group comprises a light-entering surface that is near to the light guide plate and a light-exiting surface that is far from the light guide plate, and the refractive indexes of the plurality of transparent material layers increase in sequence in a direction from the light-entering surface to the light-exiting surface. The light, when entering into the collimation diaphragm group from the light-entering surface thereof and passing through the transparent material layers, refracts at each transparent material layer and converges continuously since the refractive indexes of the plurality of transparent material layers increase in sequence. Therefore, the viewing angle of the backlight module can be reduced. Preferably, the refractive indexes of the transparent material layers increase in sequence in the direction from the light-entering surface to the light-exiting surface with a same value. In this case, the light can refract uniformly at each layer thereof, and can exit from the backlight module in a more uniform manner. As a result, the viewing angle of the backlight module can bring about a relatively comfortable experience to the users.

According to some implementations, the optical diaphragm group comprises a plurality of optical diaphragms, and the collimation diaphragm group is arranged between two optical diaphragms of the optical diaphragm group. The collimation diaphragm group and the optical diaphragm group can be assembled together through arranging the collimation diaphragm group in the optical diaphragm group. The integrated structure thereof would facilitate the installation of the backlight module.

According to some implementations, the optical diaphragm group comprises a light-entering side that is near to the light guide plate, and the collimation diaphragm group is arranged on the light-entering side of the optical diaphragm group. Preferably, the collimation diaphragm group is arranged on a surface of the light-entering side of the optical diaphragm group. The arrangement is simple, which would facilitate the installation and fixation of the collimation diaphragm group. The collimation diaphragm group only needs to be affixed to an outside surface of the optical diaphragm group.

The present disclosure further provides a liquid crystal display device, which comprises the aforesaid backlight module.

The present disclosure further provides a liquid crystal display device, which comprises a liquid crystal panel, an optical diaphragm group, and a light guide plate that are arranged in sequence, wherein a collimation diaphragm group is arranged between the liquid crystal panel and the optical diaphragm group, and the collimation diaphragm group is made of a plurality of transparent material layers with different refractive indexes in a laminated manner.

In the liquid crystal display device according to the present disclosure, the collimation diaphragm group in the aforesaid backlight module is arranged between the liquid crystal panel and the optical diaphragm group, and the collimation diaphragm group can be arranged in a suitable position. With the collimation diaphragm group, on the one hand, the viewing angle of the liquid crystal display device can be reduced, and thus the requirement of special users can be met. On the other hand, a satisfactory effect of the collimation diaphragm group can be obtained through arranging the position of the collimation diaphragm group, so that the assembling thereof can be simplified. Moreover, in the liquid crystal display device according to the present disclosure, the light is more convergent since the viewing angle is reduced. Therefore, the brightness of the liquid crystal display device can be improved, and a power consumption of the liquid crystal display device can be reduced.

According to some implementations, the liquid crystal panel comprises a first surface that is near to the light guide plate, and the collimation diaphragm group is arranged on the first surface. The collimation diaphragm group can be affixed to the first surface of the liquid crystal panel, so that the assembling thereof can be simplified, and the production efficiency can be improved.

According to some implementations, the optical diaphragm group comprises a second surface that is far from the light guide plate, and the collimation diaphragm group is arranged on the second surface. In this case, the collimation diaphragm group is arranged on a surface of the optical diaphragm group, which would facilitate the installation of the collimation diaphragm group.

The present disclosure has the following advantages compared with the prior art.

1) In the backlight module according to the present disclosure, the collimation diaphragm group is designed appropriately. That is, through selecting the thicknesses of collimation diaphragms, the number of layers thereof, and the refractive index of each layer, the light can be made more convergent after passing through the collimation diaphragm group. In this case, the viewing angle of the backlight module can be reduced, and thus the requirement of special users can be met.

2) In the backlight module according to the present disclosure, a satisfactory effect of the collimation diaphragm group can be obtained through arranging the position of the collimation diaphragm group, so that the assembling thereof can be simplified.

3) In the backlight module and the liquid crystal display device according to the present disclosure, the light is more convergent since the viewing angle is reduced. Therefore, the brightness of the backlight module and the liquid crystal display device can be improved, and the power consumption of the backlight module and the liquid crystal display device can be reduced.

### BRIEF DESCRIPTION OF THE DRAWINGS

The present disclosure will be illustrated in detail hereinafter with reference to the embodiments and the drawings. In the drawings:

FIG. 1 schematically shows a structure of a collimation diaphragm group of a backlight module according to the present disclosure;

FIG. 2 schematically shows a structure of a liquid crystal display device according to the present disclosure; and

FIG. 3 schematically shows a structure of another liquid crystal display device according to the present disclosure.

In the drawings, a same component is represented by a same reference sign. The drawings are not drawn according to actual scale.

### DETAILED DESCRIPTION OF THE EMBODIMENTS

The present disclosure will be further illustrated hereinafter with reference to the drawings.

The details described herein are only specific examples used for discussing the implementations of the present disclosure. The most useful and most understandable description on the principle and concept of the present disclosure is provided. The structural details which go beyond the scope of basic understanding of the present disclosure are not provided herein. Therefore, those skilled in the art can clearly understand, based on the description and the accompanying drawings, how to implement the present disclosure in different ways.

FIG. 1 schematically shows a structure of a collimation diaphragm group 50 of a backlight module according to the present disclosure. As shown in FIG. 1, the collimation diaphragm group 50 consists of a plurality of transparent material layers 51 (only one of the layers is indicated in FIG. 1 as an example) with different refractive indexes in a laminated manner. The viewing angle of the backlight module can be controlled through selecting the refractive indexes of different transparent material layers 51 and the number of layers thereof. The more layers there are, and the larger the refractive index difference between two adjacent layers would be, the smaller the viewing angle of the backlight module would become.

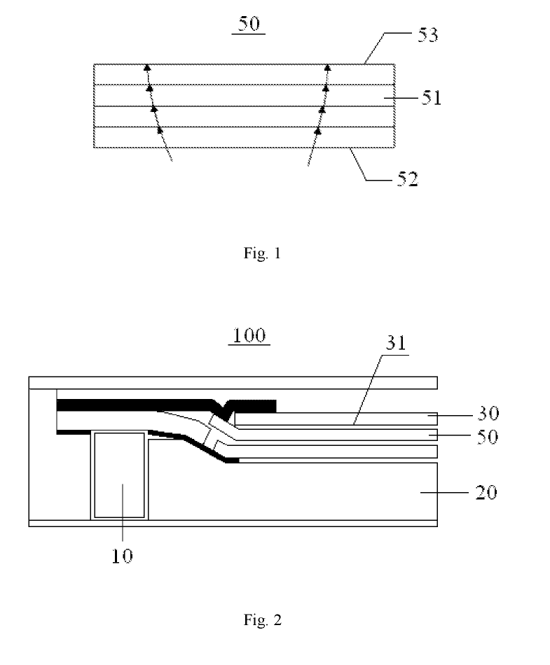

Preferably, as shown in FIG. 1 and FIG. 2, the collimation diaphragm group 50 comprises a light-entering surface 52 that is near to the light guide plate 20 and a light-exiting surface 53 that is far from the light guide plate 20, and the refractive indexes of the plurality of transparent material layers 51 increase in sequence in a direction from the light-entering surface 52 to the light-exiting surface 53. For example, as shown in FIG. 1, the collimation diaphragm group 50 comprises four layers of transparent materials, and the refractive indexes of the transparent material layers increase in sequence from bottom up. The light, when entering into the collimation diaphragm group from the light-entering surface 52 and passing through the transparent material layers, refracts at each transparent material layer and converges continuously since the refractive indexes of the transparent material layers increase in sequence. Therefore, the viewing angle of the backlight module can be reduced. It can be understood that, if the refractive indexes of the transparent material layers 51 decrease in sequence from bottom up, the light would diverge continuously after the refraction of each of the transparent material layers. Therefore, based on the aforesaid technical inspiration, the present disclosure can also be used for increasing the viewing angle of the backlight module.

Preferably, the refractive indexes of the transparent material layers 51 increase in sequence in the direction from the light-entering surface 52 to the light-exiting surface 53 with a same value. In this case, the light can refract uniformly at each layer thereof, and can exit from the backlight module in a more uniform manner. As a result, the viewing angle of the backlight module can bring about a relatively comfortable experience to the users.

FIG. 2 schematically shows a structure of a liquid crystal display device 100 comprising the aforesaid collimation diaphragm group 50. The backlight module of the liquid crystal display device 100 comprises a light guide plate 20, an optical diaphragm group 30 that is arranged on one side of the light guide plat 20, and a collimation diaphragm group 50 that is arranged between the light guide plate 20 and the optical diaphragm group 30.

In the backlight module according to the present disclosure, on the one hand, the collimation diaphragm group 50 is designed appropriately. That is, through selecting the thickness of the collimation diaphragm group 50, the number of layers thereof, and the refractive index of each layer, the light that is emitted by a light source 10 can be made more convergent after passing through the collimation diaphragm group 50. In this case, the viewing angle of the backlight module can be reduced, and thus the requirement of special users can be met. On the other hand, a satisfactory effect of the collimation diaphragm group 50 can be obtained through arranging the position of the collimation diaphragm group 50, so that the assembling thereof can be simplified. Moreover, in the backlight module according to the present disclosure, the light is more convergent since the viewing angle is reduced. Therefore, the brightness of the backlight module can be improved, and the power consumption of the backlight module can be reduced.

According to the embodiment as shown in FIG. 2, the optical diaphragm group 30 comprises a plurality of optical diaphragms (only one optical diaphragm is indicated in FIG. 2 as an example), and the collimation diaphragm group 50 is arranged between two optical diaphragms of the optical diaphragm group. The collimation diaphragm group 50 and the optical diaphragm group 30 can be assembled together through arranging the collimation diaphragm group 50 in the optical diaphragm group, and the integrated structure thereof would facilitate the installation of the backlight module.

In addition, the optical diaphragm group 30 comprises a light-entering side that is near to the light guide plate 20, and the collimation diaphragm group is arranged on the light-entering side of the optical diaphragm group 30. Preferably, the collimation diaphragm group 50 is arranged on a surface 31 of the light-entering side of the optical diaphragm group 30. The arrangement is simple, which would facilitate the installation and fixation of the collimation diaphragm group. The collimation diaphragm group 50 only needs to be affixed to the surface 31 of the optical diaphragm group.

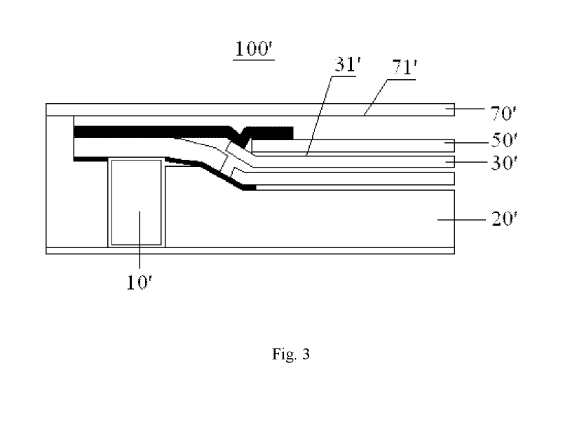

FIG. 3 schematically shows a structure of a liquid crystal display device 100′ according to the present disclosure. The liquid crystal display device 100′ comprises a liquid crystal panel 70′, an optical diaphragm group 30′, and a light guide plate 20′ that are arranged in sequence, wherein a collimation diaphragm group 50′ is arranged between the liquid crystal panel 70′ and the optical diaphragm group 30′. The collimation diaphragm group 50′ has the same properties as the aforesaid collimation diaphragm group 50. The light that is emitted by a light source 10′ would become more convergent after passing through the collimation diaphragm group 50′, so that the viewing angle of the liquid crystal display device 100′ can be reduced.

Preferably, the liquid crystal panel 70′ comprises a first surface 71′ that is near to the light guide plate, and the collimation diaphragm group 50′ is arranged on the first surface 71′. The collimation diaphragm group 50′ can be affixed to the first surface 71′ of the liquid crystal panel, so that the assembling thereof can be simplified, and the production efficiency can be improved.

Preferably, the optical diaphragm group 30′ comprises a second surface 31′ that is far from the light guide plate 20′, and the collimation diaphragm group 50′ is arranged on the second surface 31′. In this case, the collimation diaphragm group 50′ is arranged on a surface of the optical diaphragm group 30′, which would facilitate the installation of the collimation diaphragm group 50′.

It can be understood that, according to the present disclosure, the collimation diaphragm group can be arranged in a suitable position according to actual needs, i.e., the collimation diaphragm group is not limited by the position described herein.

It should be noted that, the above embodiments are described only for better understanding, rather than restricting the present disclosure. Those skilled in the art can make amendments to the present disclosure within the scope as defined in the claims and without departing from the spirit and scope of the present disclosure. The present disclosure is described according to specific methods, materials, and implementations, but the present disclosure is not restricted by the details disclosed herein. On the contrary, the present disclosure is applicable for the equivalent structures, methods, and applications with the same functions as those defined in the claims.

1. A backlight module, comprising:
a light guide plate;
an optical diaphragm group that is arranged on one side of the light guide plate; and
a collimation diaphragm group that is arranged between the light guide plate and the optical diaphragm group.

2. The backlight module according to claim 1, wherein the collimation diaphragm group consists of a plurality of transparent material layers with different refractive indexes in a laminated manner.

3. The backlight module according to claim 2, wherein the collimation diaphragm group comprises a light-entering surface that is near to the light guide plate and a light-exiting surface that is far from the light guide plate, and the refractive indexes of the plurality of transparent material layers increase in sequence in a direction from the light-entering surface to the light-exiting surface.

4. The backlight module according to claim 1, wherein the optical diaphragm group comprises a plurality of optical diaphragms, and the collimation diaphragm group is arranged between two optical diaphragms of the optical diaphragm group.

5. The backlight module according to claim 2, wherein the optical diaphragm group comprises a plurality of optical diaphragms, and the collimation diaphragm group is arranged between two optical diaphragms of the optical diaphragm group.

6. The backlight module according to claim 3, wherein the optical diaphragm group comprises a plurality of optical diaphragms, and the collimation diaphragm group is arranged between two optical diaphragms of the optical diaphragm group.

7. The backlight module according to claim 1, wherein the optical diaphragm group comprises a light-entering side that is near to the light guide plate, and the collimation diaphragm group is arranged on the light-entering side of the optical diaphragm group.

8. The backlight module according to claim 2, wherein the optical diaphragm group comprises a light-entering side that is near to the light guide plate, and the collimation diaphragm group is arranged on the light-entering side of the optical diaphragm group.

9. The backlight module according to claim 3, wherein the optical diaphragm group comprises a light-entering side that is near to the light guide plate, and the collimation diaphragm group is arranged on the light-entering side of the optical diaphragm group.

10. A liquid crystal display device, comprising a backlight module, wherein the backlight module comprises:
a light guide plate;
a optical diaphragm group that is arranged on one side of the light guide plate; and
a collimation diaphragm group that is arranged between the light guide plate and the optical diaphragm group.

11. The liquid crystal display device according to claim 10, wherein the collimation diaphragm group consists of a plurality of transparent material layers with different refractive indexes in a laminated manner.

12. The liquid crystal display device according to claim 11, wherein the collimation diaphragm group comprises a light-entering surface that is near to the light guide plate and a light-exiting surface that is far from the light guide plate, and the refractive indexes of the plurality of transparent material layers increase in sequence in a direction from the light-entering surface to the light-exiting surface.

13. The liquid crystal display device according to claim 10, wherein the optical diaphragm group comprises a plurality of optical diaphragms, and the collimation diaphragm group is arranged between two optical diaphragms of the optical diaphragm group.

14. The liquid crystal display device according to claim 10, wherein the optical diaphragm group comprises a light-entering side that is near to the light guide plate, and the collimation diaphragm group is arranged on the light-entering side of the optical diaphragm group.

15. A liquid crystal display device, comprising a liquid crystal panel, an optical diaphragm group, and a light guide plate that are arranged in sequence, wherein a collimation diaphragm group is arranged between the liquid crystal panel and the optical diaphragm group, and the collimation diaphragm group is made of a plurality of transparent material layers with different refractive indexes in a laminated manner.

16. The liquid crystal display device according to claim 15, wherein the collimation diaphragm group comprises a light-entering surface that is near to the light guide plate and a light-exiting surface that is far from the light guide plate, and the refractive indexes of the plurality of transparent material layers increase in sequence in a direction from the light-entering surface to the light-exiting surface.

17. The liquid crystal display device according to claim 15, wherein the liquid crystal panel comprises a first surface that is near to the light guide plate, and the collimation diaphragm group is arranged on the first surface.

18. The liquid crystal display device according to claim 16, wherein the liquid crystal panel comprises a first surface that is near to the light guide plate, and the collimation diaphragm group is arranged on the first surface.

19. The liquid crystal display device according to claim 15, wherein the optical diaphragm group comprises a second surface that is far from the light guide plate, and the collimation diaphragm group is arranged on the second surface.

20. The liquid crystal display device according to claim 16, wherein the optical diaphragm group comprises a second surface that is far from the light guide plate, and the collimation diaphragm group is arranged on the second surface.
